(19) United States
(12) Patent Application Publication
(10) Pub. No.: US 2012/0218749 A1
(43) Pub. Date: Aug. 30, 2012

(54) LIGHTING-EMITTING DEVICE

(76) Inventor: Po-Jen SU, Tainan City (TW)

(21) Appl. No.: 13/348,296

(22) Filed: Jan. 11, 2012

(30) Foreign Application Priority Data
Feb. 24, 2011 (TW) 100106139

(51) Int. Cl. F21V 9/00

(52) U.S. Cl. 362/231

(57) ABSTRACT

A light-emitting device including a substrate and a plurality of the semiconductor light-emitting diode dice having dominant wavelengths between 440 nm and 490 nm is disclosed. The semiconductor light-emitting diode dice are disposed on the substrate and electrically connected to the substrate. The difference in the wavelength of the semiconductor light-emitting diode dice between the maximum dominant wavelength and the minimum dominant wavelength is at least 10 nm and the average dominant wavelength is between 450 nm and 470 nm. Therefore, by the above arrangement, it not only homogenizes the light emitted from the light-emitting device of the present invention, but also depletes the surplus stocks of the semiconductor light-emitting diode dice on the production line.

### CROSS-REFERENCE TO RELATED APPLICATION

This application claims the benefit of Taiwan Patent Application No. 100106139, filed on Feb. 24, 2011, in the Taiwan Intellectual Property Office of the Republic of China, the disclosure of which is incorporated herein in its entirety by reference.

### BACKGROUND OF THE INVENTION

1. Field of the Invention

The present invention relates to a light-emitting device, and particularly, to a light-emitting device for controlling the wavelength and waveband of the semiconductor light-emitting diode dice.

2. Description of the Related Art

Currently, the known techniques related to improve and to homogenize the luminance of light-emitting diodes (LEDs) may be divided into: (1) the design of substrates (including light extraction and heat dissipation); (2) the selection and arrangement of chips; (3) the way of die bonding; (4) the type or diameter of gold bonding wires; (5) the type and coating structure of phosphor; and (6) the curvature and refractive index of lens. As above-mentioned, each critical process may affect LEDs deeply to heat dissipation, luminous flux, light-emitting efficiency, correlated color temperature (CCT), color rendering index (CRI), light color uniformity and lifetime. Thus, it must emphasize on every detail in order to exert the light-emitting efficiency of LEDs superbly. Therefore, the present invention provides a light-emitting device to control the range of wavelengths of the semiconductor light-emitting diode dice, so as to homogenize the light emitted from the light-emitting device and simultaneously deplete the surplus stocks of the semiconductor light-emitting diode dice on the production line.

### SUMMARY OF THE INVENTION

To homogenize the illumination brightness of light-emitting device, the present invention provides a light-emitting device characterized in comprising a plurality of the semiconductor light-emitting diode dice having dominant wavelengths within a control range such that the light emitted from the light-emitting device can be homogenized by controlling the dominant wavelengths of the semiconductor light-emitting diode dice.

According to an object of the present invention, the inventor provides a light-emitting device comprising a substrate and a plurality of the semiconductor light-emitting diode dice having dominant wavelengths between 440 nm and 490 nm. Wherein, the semiconductor light-emitting diode dice are disposed on the substrate and electrically connected to the substrate. Furthermore, the difference in wavelength of the semiconductor light-emitting diode dice between the maximum dominant wavelength and the minimum dominant wavelength is at least 10 nm.

The average dominant wavelength is between 450 nm and 470 nm by uniformly arranging the dominant wavelength of above-mentioned the semiconductor light-emitting diode dice. More specifically speaking, the average dominant wavelength is better between 453 nm and 460 nm. As the above arrangement, the light-emitting device of the present invention not only homogenizes the emitted light but also depletes the surplus stocks of the semiconductor light-emitting diode dice on the production line. In other words, firstly, it may suppose that the center semiconductor light-emitting diode die has the best dominant wavelength, and other semiconductor light-emitting diode dice may be arranged randomly when they meet the conditions such as the range of dominant wavelengths and wavebands, the difference in wavelength of the light-emitting diode dice between the maximum dominant wavelength and the minimum dominant wavelength, and the average dominant wavelength. In addition, the light-emitting device of the present invention may further comprises auxiliary semiconductor light-emitting diode dice, which have other wavebands, including, for example, a red semiconductor light-emitting diode die having dominant wavelength between 620 nm and 770 nm and a green semiconductor light-emitting diode die having dominant wavelength between 490 nm and 580 nm. Thus, by mixing the light with different color uniformly, a white light-emitting device may be obtained.

Furthermore, the light-emitting device of the present invention may also comprise a package structure covering all of the semiconductor light-emitting diode dice. It should be noted, the package structure has many different configurations. The first package structure is a double-layer structure called remote phosphor structure comprising a phosphor layer and a package layer. The phosphor layer comprises a transparent resin mixed with yellow phosphor. The package layer comprises silicone or resin glue. The second package structure is uniform distribution structure filling with phosphor. The third package structure is conformal distribution structure whose phosphor adhered to the semiconductor light-emitting diode dice. In summary, the semiconductor light-emitting diode dice emit light to excite the phosphor layer to emit exciting light having the wavelength between 520 nm and 660 nm, so as to achieve color temperature adjustment and lighting luminance optimization.

As above-mentioned, the light-emitting device of the present invention may have one or more characteristics and advantages as described below:

(1) The light-emitting device of the present invention may control the dominant wavelengths of a plurality of the semiconductor light-emitting diode dice to be between 440 nm and 490 nm, the difference in wavelength of the semiconductor light-emitting diode dice between the maximum dominant wavelength and the minimum dominant wavelength to be at least 10 nm, and the average dominant wavelength to be between 450 nm and 470 nm. Therefore, the light-emitting device not only homogenizes the light emitted from the light-emitting device but also depletes the surplus stocks of the semiconductor light-emitting diode dice.

(2) In the embodiment of the light-emitting device of the present invention, the package structure doping with phosphor has high color control ability.

(3) In the embodiment of the light-emitting device of the present invention, the package structure comprising silicone has characteristics such as high refractivity, high thermal resistance, insulativity, chemical stability and high light transmission.

### BRIEF DESCRIPTION OF THE DRAWINGS

FIG. 1 is a schematic view showing the light-emitting device according to the first embodiment of the present invention;

FIG. 2 is a schematic view showing the light-emitting device according to the second embodiment of the present invention;

FIG. 3 is a schematic view showing the light-emitting device according to the third embodiment of the present invention;

FIG. 4 is a schematic view showing the light-emitting device according to the fourth embodiment of the present invention; and

FIG. 5 is a schematic view showing the light-emitting device according to the fifth embodiment of the present invention.

### DETAILED DESCRIPTION OF THE PREFERRED EMBODIMENTS

The present invention will be apparent from the following detailed description according to the embodiments of the light-emitting device, which proceeds with reference to the accompanying drawings for better understanding, wherein the same references relate to the same elements.

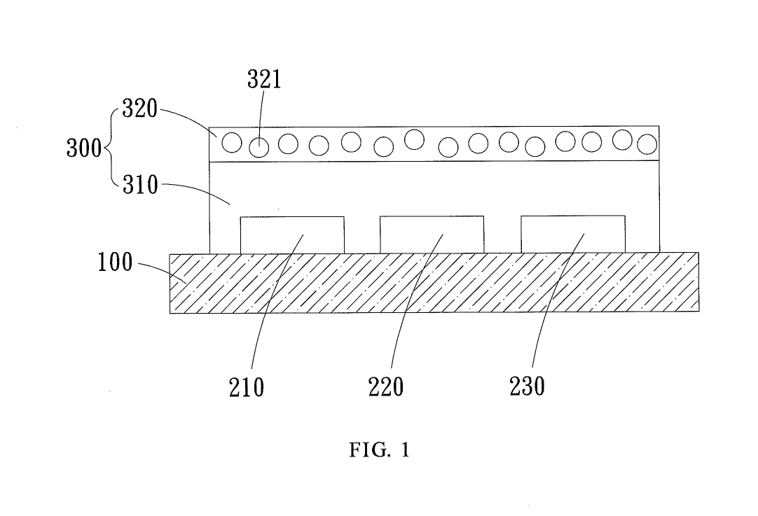

First, referring to FIG. 1, it is a schematic view showing the light-emitting device according to the first embodiment of the present invention. In the first embodiment in FIG. 1, the light-emitting device comprises a substrate 100 and a plurality of the semiconductor light-emitting diode dice 210-230. Wherein, the semiconductor light-emitting diode dice 210-230 are disposed on the substrate 100 and electrically connected to the substrate 100. In this case, the semiconductor light-emitting diode dice emit visible light with similar color, such as blue light in this first embodiment, whose dominant wavelength of the light emitted is between 440 nm and 490 nm. Moreover, the difference in wavelength of the semiconductor light-emitting diode dice 210-230 between the maximum dominant wavelength and the minimum dominant wavelength is at least 10 nm. Specifically speaking, in FIG. 1, the dominant wavelength of the first semiconductor light-emitting diode die 210 is 445 nm, the dominant wavelength of the second semiconductor light-emitting diode die 220 is 455 nm, the dominant wavelength of the third semiconductor light-emitting diode die 230 is 465 nm, the dominant wavelengths of above the semiconductor light-emitting diode dice 210-230 are between 440 nm and 490 nm, which are so-called blue light waveband. Besides, the difference in wavelength between the wavelength of the third semiconductor light-emitting diode die 230, which has the maximum wavelength, and the wavelength of the first semiconductor light-emitting diode die 210, which has the minimum wavelength, is 20 nm, which is more than 10 nm.

The average dominant wavelength is between 450 nm and 470 nm by uniformly arranging the dominant wavelength of the above-mentioned the semiconductor light-emitting diode dice 210-230, such as the average wavelength according to the first embodiment is 455 nm. More specifically speaking, the average dominant wavelength of the semiconductor light-emitting diode dice 210-230 is preferably ranged between 453 nm and 460 nm. As the above arrangement, the light-emitting device of the present invention not only homogenizes the emitting-light but also depletes the surplus stocks of the semiconductor light-emitting diode dice 210-230 on the production line. In other words, firstly, it may suppose that the center semiconductor light-emitting diode die 220 has the best dominant wavelength, and others semiconductor light-emitting diode dice 210, 230 may be arranged randomly when they meet the conditions such as the range of dominant wavelength and waveband, the difference in wavelength of the semiconductor light-emitting diode dice between the maximum dominant wavelength and the minimum dominant wavelength, and the average dominant wavelength. Meanwhile, by the arrangements of the multiple semiconductor light-emitting diode dice 210-230 that matched above-mentioned conditions, the average dominant wavelength of the semiconductor light-emitting diode dice 210-230 may close to the best dominant wavelength.

The light-emitting device further comprises a package structure 300 covering the semiconductor light-emitting diode dice 210-230. It should be noted that the package structure 300 may have many different configurations upon demands. The package structure 300 according to the first embodiment comprises a phosphor layer 320 and a package layer 310. The phosphor layer 320 comprises a transparent resin mixed with yellow phosphor 321. The package layer 310 comprises silicone or resin glue. The package structure 300 is defined as double-layer structure of remote phosphor structure. The semiconductor light-emitting diode dice 210-230 may emit light to excite the phosphor layer 320 to emit exciting light having the dominant wavelength between 520 nm and 660 nm, so as to achieve color temperature adjustment and lighting luminance optimization.

By the way, the total number of the semiconductor light-emitting diode dice 210-230 of the present invention is two to five, and the semiconductor light-emitting diode dice 210-230 are electrically connected in parallel to each other.

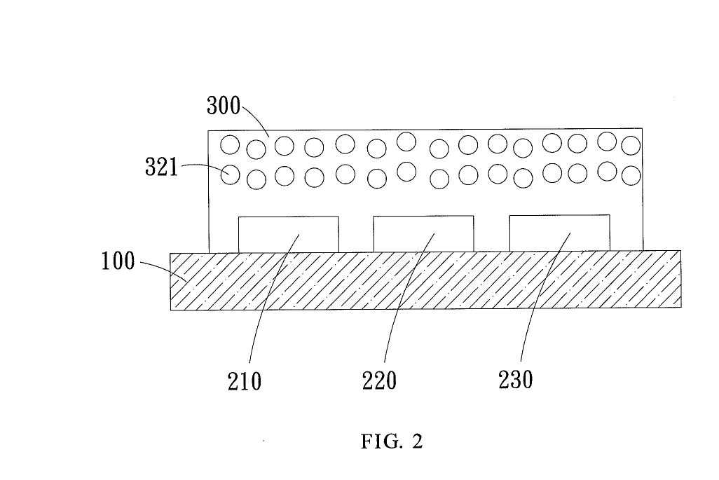

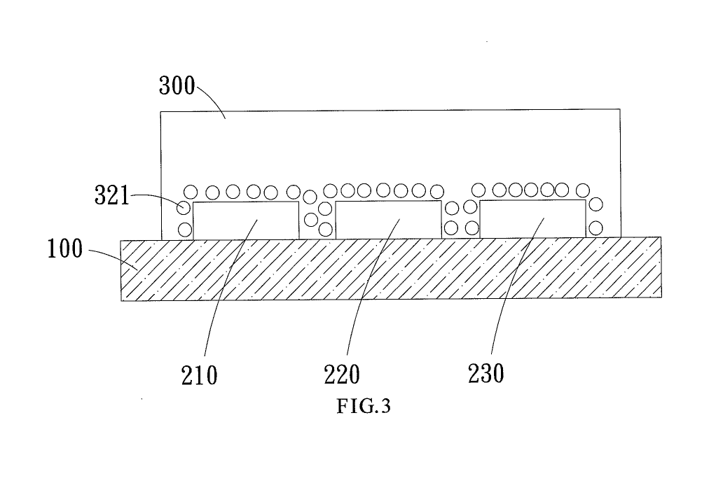

Referring to FIGS. 2 and 3, they are schematic views showing the light-emitting device according to the second and the third embodiments of the present invention, respectively. Basically, except the different arrangement of the package structure 300 in the second and the third embodiments, there are no other differences comparing to the first embodiment. As above-mentioned, the package structure 300 has many different configurations. The package structure 300 is filled with phosphor 321 according to the second embodiment, which is traditionally defined as a uniform distribution structure. In addition, the phosphor 321 of the package structure 300 is disposed adhering to the semiconductor light-emitting diode dice 210-230 according to the third embodiment. The package structure 300 is generally defined as a conformal distribution which is mainly aimed at the improvement of the color uniformity.

In summary, the main object of the light-emitting device of the present invention is to homogenize the light-emitting wavelength. The other object is to deplete the surplus stocks of the semiconductor light-emitting diode dice 210-230. If the second semiconductor light-emitting diode die 220 (i.e., the center semiconductor light-emitting diode die), which has a default dominant wavelength, is selected, the other semiconductor light-emitting diode dice 210, 230 will be arranged around the second light-emitting diode die 220 as long as they meet the conditions such as the range of the waveband, the difference in wavelength, and the average dominant wavelength, so that the objects may be achieved.

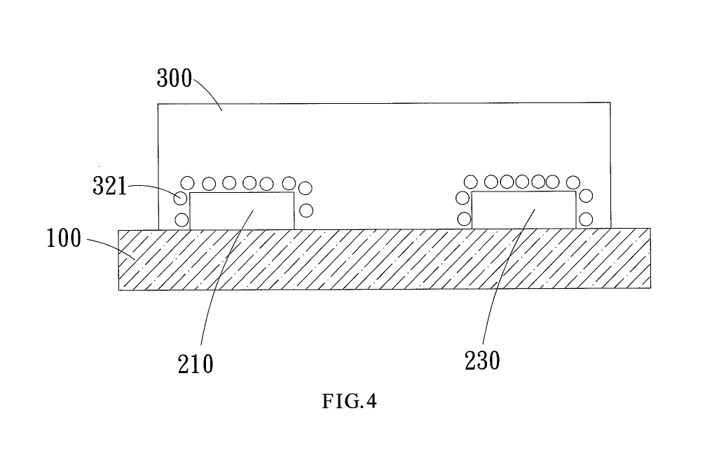

Referring to FIG. 4, it is a schematic view showing the light-emitting device according to the fourth embodiment of the present invention. In FIG. 4, the total number of the semiconductor light-emitting diode dice 210, 230 is two. The phosphor 321 of the package structure 300 is disposed adhering to the semiconductor light-emitting diode dice 210, 230, respectively. It should be noted that even if there exist only the semiconductor light-emitting diode dice 210, 230, the objective of the light-emitting device of the present invention will still be achieved, namely, homogenizing the wavelength as long as the semiconductor light-emitting diode dice 210, 230 meet the above-mentioned conditions such as the range of the waveband, the difference in wavelength and the average dominant wavelength.

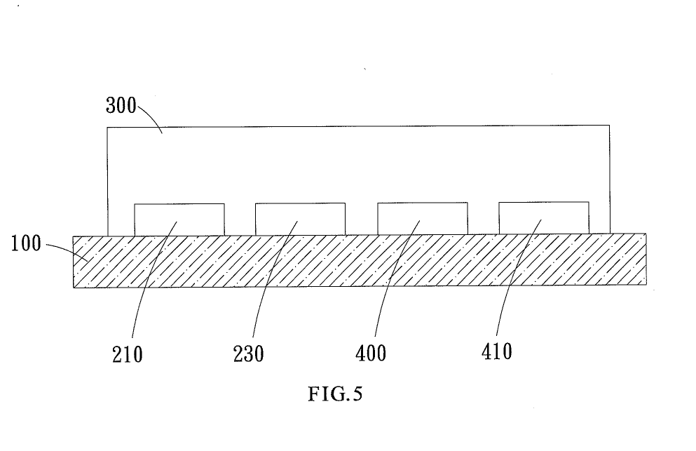

Referring to FIG. 5, it is a schematic view showing the light-emitting device according to the fifth embodiment of the present invention. In FIG. 5, there are four semiconductor light-emitting diode dice 210, 230, 400, and 410 in the package structure 300. The dominant wavelengths of the semiconductor light-emitting diode dice 210, 230 are between 440 nm and 490 nm. The dominant wavelength of the auxiliary semiconductor light-emitting diode die 400 is between 620 nm and 770 nm. The dominant wavelength of the auxiliary semiconductor light-emitting diode die 410 is between 490 nm and 580 nm. The semiconductor light-emitting diode dice 210, 230 may emit blue light, the semiconductor light-emitting diode die 400 may emit red light, and the semiconductor light-emitting diode die 410 may emit green light. Thus, after mixing uniformly, a white light-emitting device may be obtained.

In summation, although the present invention has been described with reference to the foregoing five embodiments, it will be understood that the invention is not limited to the details thereof. Various equivalent variations and modifications may still occur to those skilled in this art in view of the teachings of the present invention. Thus, all such variations and equivalent modifications are also embraced within the scope of the invention as defined in the appended claims.

What is claimed is:

1. A light-emitting device, comprising:
a substrate; and
a plurality of semiconductor light-emitting diode dice having dominant wavelengths between 440 nm and 490 nm, said semiconductor light-emitting diode dice disposed on said substrate and electrically connected to said substrate, wherein a difference in wavelength of said semiconductor light-emitting diode dice between maximum dominant wavelength and minimum dominant wavelength is at least 10 nm.

2. The light-emitting device of claim 1, further comprising a package structure covering said semiconductor light-emitting diode dice.

3. The light-emitting device of claim 2, wherein said package structure comprises a phosphor layer and a package layer.

4. The light-emitting device of claim 3, wherein said semiconductor light-emitting diode dice emit light to excite said phosphor layer to emit exciting light with wavelength between 520 nm and 660 nm.

5. The light-emitting device of claim 3, wherein said phosphor layer comprises a transparent resin mixed with yellow phosphor.

6. The light-emitting device of claim 1, wherein said semiconductor light-emitting diode dice have average dominant wavelength between 450 nm and 470 nm.

7. The light-emitting device of claim 1, wherein said semiconductor light-emitting diode dice have average dominant wavelength between 453 nm and 460 nm.

8. The light-emitting device of claim 1, wherein said semiconductor light-emitting diode dice are electrically connected in parallel.

9. The light-emitting device of claim 1, wherein the total number of said semiconductor light-emitting diode dice is two to five.

10. The light-emitting device of claim 1, further comprising a plurality of auxiliary semiconductor light-emitting diode dice having dominant wavelengths between 620 nm and 770 nm and between 490 nm and 580 nm, and said auxiliary semiconductor light-emitting diode dice being disposed on said substrate and electrically connected to said substrate.
